(19) United States
(12) Patent Application Publication
(10) Pub. No.: US 2014/0188445 A1
(43) Pub. Date: Jul. 3, 2014

(54) ESTIMATING TIME TO MODEL A DATA PROCESSING ENVIRONMENT

(71) Applicant: INTERNATIONAL BUSINESS MACHINES CORPORATION, Armonk, NY (US)

(72) Inventors: David A. Ashmore, Osage Beach, MO (US); Ann M. Moyer, Woodstock, NY (US); Nirmala Shobitha Nandi, Fishkill, NY (US); John Zupet, St Leonards (AU)

(73) Assignee: International Business Machines Corporation, Armonk, NY (US)

(21) Appl. No.: 13/732,651

(22) Filed: Jan. 2, 2013

(51) Int. Cl. G06F 17/50

(52) U.S. Cl. CPC G06F 17/5009
USPC 703/2

(57) ABSTRACT

A method, system, and computer program product for estimating an amount of time to model a data processing environment are provided in the illustrative embodiments. A set of analysis parameters is selected. A sum of a subset of the set of analysis parameters is computed. A logarithmic value of the sum is computed. The logarithmic value is weighted. The amount of time to model the data processing environment is estimated using the logarithmic value.

### TECHNICAL FIELD

The present invention relates generally to a method, system, and computer program product for modeling a data processing environment. More particularly, the present invention relates to a method, system, and computer program product for source record management for estimating the time needed to model a data processing environment.

### BACKGROUND

Numerous components coexist in a data processing environment. The components in a data processing environment can be hardware components, software components, or a combination thereof. For example, any number of computers, data storage devices, networking equipment, server applications, business function applications, databases, client applications, virtual servers, logical partitions, and partition management firmware can be found in a typical data processing environment.

A component in a given data processing environment offers a variety of functions, services, and features. Knowledge of such functions, services, and features is typically available from documentation about the component. For example, a software manufacturer may provide technical documentation of the features and functions of a software application, which may be a component in a data processing environment. An installer of the software application component may provide additional information about the systems used to install the component. An operator of the data processing environment may further document associations of the software application component as such associations are formed with other components in the data processing environment over a period of operation.

An application analysis tool may also provide similar information about a component. For example, an application analysis tool may invoke a monitoring function in the software application component, review a log file, or trace the events associated with the component to identify the component's sub-components, functions, features, services or associations.

Complex data processing environments can include thousands if not millions of hardware, firmware, and software components. Consequently, a large number of sub-components, functions, features, services or associations can exist amongst the components in such an environment.

A model of a given data processing environment enables certain activities that are to be performed with respect to the data processing environment. For example, a model of the data processing environment is useful for identifying the components that should participate in an upgrade or migration task.

### SUMMARY

The illustrative embodiments provide a method, system, and computer program product for estimating the time needed to model a data processing environment. In at least one embodiment, a method for estimating an amount of time to model a data processing environment is provided. The method includes selecting using one or more processors, a set of analysis parameters. The method further includes computing, using the one or more processors, a sum of a subset of the set of analysis parameters. The method further includes computing, using the one or more processors, a logarithmic value of the sum. The method further includes weighting, using the one or more processors, the logarithmic value. The method further includes estimating, using the one or more processors, the amount of time to model the data processing environment using the logarithmic value.

In at least one embodiment, a computer program product for estimating an amount of time to model a data processing environment is provided. The computer program product includes one or more computer-readable storage devices and program instructions stored on at least one of the one or more storage devices, the program instructions including program instructions to select using one or more processors, a set of analysis parameters. The program instructions further include program instructions to compute, using the one or more processors, a sum of a subset of the set of analysis parameters. The program instructions further include program instructions to compute, using the one or more processors, a logarithmic value of the sum. The program instructions further include program instructions to weight, using the one or more processors, the logarithmic value. The program instructions further include program instructions to estimate, using the one or more processors, the amount of time to model the data processing environment using the logarithmic value.

In at least one embodiment, a computer system for estimating an amount of time to model a data processing environment is provided. The computer system includes one or more processors, one or more computer-readable memories, one or more computer-readable storage devices, and program instructions stored on at least one of the one or more storage devices for execution by at least one of the one or more processors via at least one of the one or more memories, the program instructions including program instructions to select using one or more processors, a set of analysis parameters. The program instructions further include program instructions to compute, using the one or more processors, a sum of a subset of the set of analysis parameters. The program instructions further include program instructions to compute, using the one or more processors, a logarithmic value of the sum. The program instructions further include program instructions to weight, using the one or more processors, the logarithmic value. The program instructions further include program instructions to estimate, using the one or more processors, the amount of time to model the data processing environment using the logarithmic value.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of example configuration for estimating the time needed to model a data processing environment in accordance with an illustrative embodiment;

FIG. 4A depicts an example compilation of several example sets of contributing factors that can be used for weight factor determination in accordance with an illustrative embodiment;

FIG. 4B depicts an example compilation of several example sets of analysis parameters that can be used for estimating the time needed to model a data processing environment in accordance with an illustrative embodiment;

FIG. 4C depicts an example compilation of several example issues, troubles, problems, action-items associated with a component that can be used for estimating the time needed to model a data processing environment in accordance with an illustrative embodiment;

FIG. 4D depicts example computations, and an example manner of compiling the computed or derived values resulting from those computations, for estimating the time needed to model a data processing environment in accordance with an illustrative embodiment;

FIG. 4E depicts example computations of time estimates for modeling a data processing environment in accordance with an illustrative embodiment;

FIG. 5 depicts a flowchart of an example process for estimating the time needed to model a data processing environment in accordance with an illustrative embodiment; and

FIG. 6 depicts a flowchart of an example process for computing a component's portion of the estimated modeling time in accordance with an illustrative embodiment.

### DETAILED DESCRIPTION

The illustrative embodiments recognize that modeling a data processing environment is a complex and time consuming process. Presently available tools can identify the sub-components, functions, features, services or associations of an individual component operating in a given data processing environment. However, the illustrative embodiments rokecognize that simply knowing the sub-components, functions, features, services or associations of individual components is insufficient to estimate the time it will take to model the given data processing environment.

The illustrative embodiments used to describe the invention generally address and solve the above-described problems and other problems related to the managing component interdependencies in a data processing environment. The illustrative embodiments provide a method, system, and computer program product for discovering relationships between data processing environment components.

The illustrative embodiments provide capabilities for estimating the time needed to model a data processing environment. An embodiment recognizes that information about the components present in a data processing environment can be leveraged to produce a model of the data processing environment, which can be useful for a variety of activities within the data processing environment. The illustrative embodiments further recognize that combining such information in specific manner can provide additional insight into the amount of time the modeling activity should take.

The illustrative embodiments provide a manner of selecting a set of analysis parameters pertaining to a component of the data processing environment. The illustrative embodiments provide a manner of creating one or more pieces of derivative information using various subsets of the analysis parameters in specific formulae. The illustrative embodiments further provide a manner of combining the derivative information according to specific formulae to reveal an estimate of modeling time for modeling the data processing environment.

The illustrative embodiments are described with respect to certain analysis parameters and weights or weight factors only as examples. The specific values of such parameters or weight factors, or their contribution in any specific formula, are only examples, and are not intended to be limiting to the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

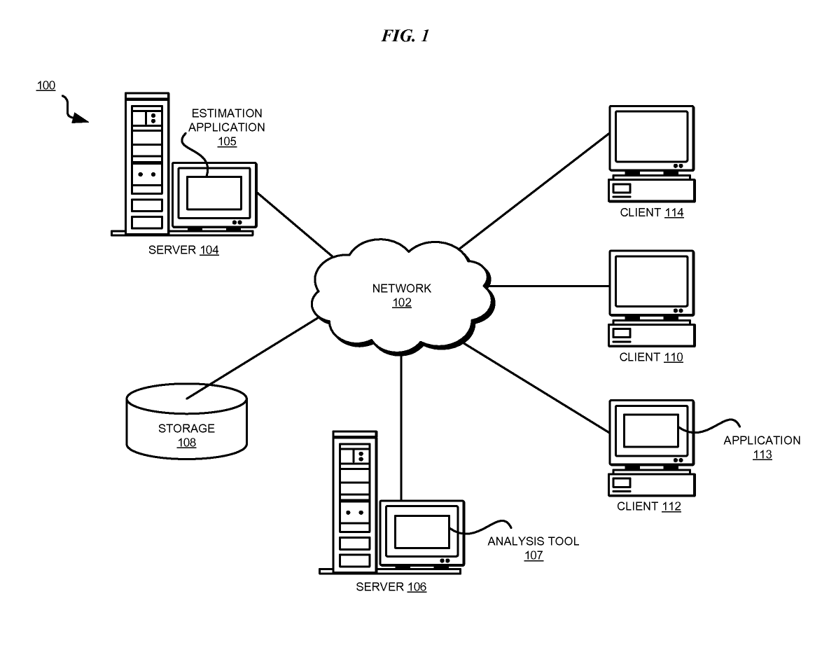

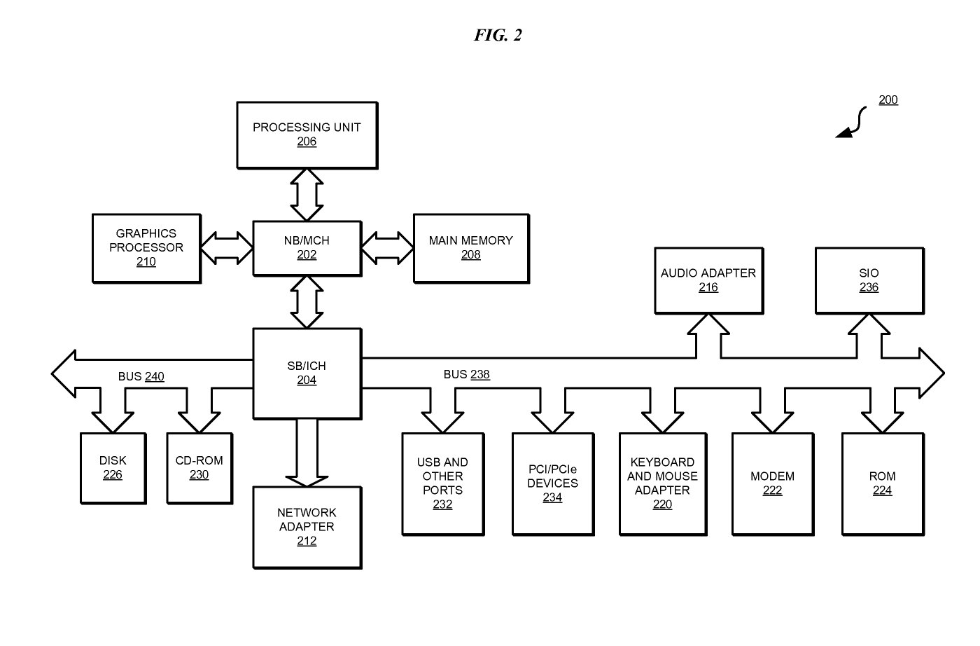

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114, may contain data and may have software applications or software tools executing thereon.

Only as an example, and without implying any limitation to such architecture, FIG. 1 depicts certain components that are usable in an example implementation of an embodiment. Estimation application 105 in server 104 is an implementation of an embodiment described herein. Application 107 in server 106 is an example analysis tool that can provide a set of analysis parameters of a component as described earlier. Application 113 is an example software application component, of which there can be any number present in a given implementation. In an example operation, application 107 analyzes application 113 for the sub-components or subsystems, services, features, functions, and association parameters of application 113. Application 107 provides these and other analysis parameters of application 113 and other components to application 105. Application 105 uses the analysis parameters, weights, and other factors as described with respect to an embodiment to estimate the modeling time needed to model data processing environment 100.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, files related to the operating system and other software applications, and applications to clients 110, 112, and 114. Clients 110, 112, and 114 may be clients to server 104 in this example. Clients 110, 112, 114, or some combination thereof, may include their own data, boot files, operating system images, files related to the operating system and other software applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. A computer readable or usable storage device does not include propagation media. Hard disk drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft° Windows° (Microsoft and Windows are trademarks of Microsoft Corporation in the United States and other countries), or Linux° (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as estimation application 105, analysis application 107, and application 113 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

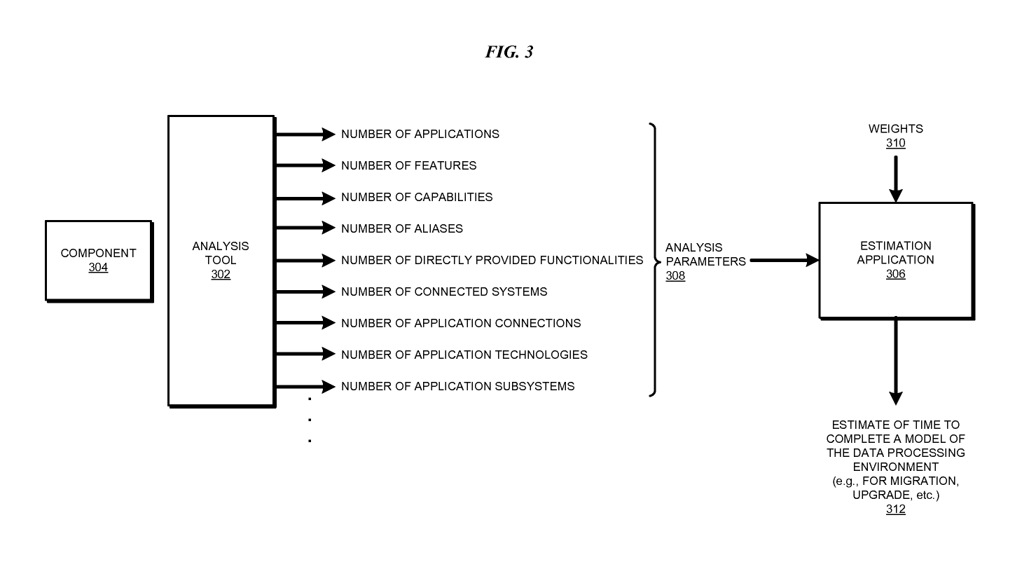

With reference to FIG. 3, this figure depicts a block diagram of example configuration for estimating the time needed to model a data processing environment in accordance with an illustrative embodiment. Analysis tool 302 is an example of analysis tool 107 in FIG. 1. Component 304 is an example component in a given data processing environment, such as application 113 in data processing environment 100 in FIG. 1. Estimation application 306 is an example application implementing an embodiment, such as application 105 in FIG. 1.

Analysis tool 302 analyzes component 304 and generates analysis parameters 308. Analysis parameters 308 form one set of input values to estimation application 306.

As an example, assume that component 304 were a software package including other software components, a software application, a software system, a software subsystem, or a software portion of another component. In an example embodiment, analysis parameters 308 include a number of applications within component 304, a number of features offered by component 304, and number of capabilities supported in component 304. Analysis parameters 308 further include a number of aliases used for referencing component 304, such as from other hardware, software, or firmware components. Analysis parameters 308 identifies a number of the functionalities directly provided by component 304, a number of systems connected with component 304, and a number of connections established with component 304. Analysis parameters 308 also point out a number of application technologies used in or with component 304, and a number of application subsystems within component 304.

Any number of other components (not shown) can be analyzed using analysis tool 302 in a manner similar to the described analysis of component 304 and the generation of analysis parameters 308 there for. Note that the specific constituents of analysis parameters 308 are listed only as an example without implying a limitation of the illustrative embodiment thereto. Other similarly purposed parameters, different parameters, additional parameters, or fewer parameters may be available from different implementations of analysis tool 302, for other components, or a combination thereof. Such other parameters are contemplated within the scope of the illustrative embodiments.

Estimation application 306 receives analysis parameters 308 as one set of input values. As another set of input values, estimation application 306 receives weights 310. Weights 310 is a set of weight factors that can be used in conjunction with one or more members of analysis parameters 308 or a value derived or calculated there from.

Weights 310 can be specified by a user or computed using other inputs. In one embodiment, a user having experience with component 304, the given data processing environment, or a combination thereof, can specify a weight in weights 310. In another embodiment, a statistical analysis of data processing environments similar to the data processing environment in which component 304 operates can provide a weight in weights 310. In another embodiment, a historical analysis of data collected in the data processing environment in which component 304 operates can provide a weight in weights 310. In another embodiment, a computation using certain contributing factors from the data processing environment in which component 304 operates can provide a weight in weights 310.

Estimation application 306 computes estimate 312 using the two sets of input values, to with, analysis parameters 308 and weights 310. Estimate 312 is an estimate of time expected to be required to complete a model of the data processing environment that includes component 304 and other components (not shown). The model of the data processing environment, completed using the estimated time, can then be used for planning any number or type of activities within the data processing environment. For example, a migration activity for certain components in the data processing environment can use the model to determine the relationships of those components with other components in the data processing environment.

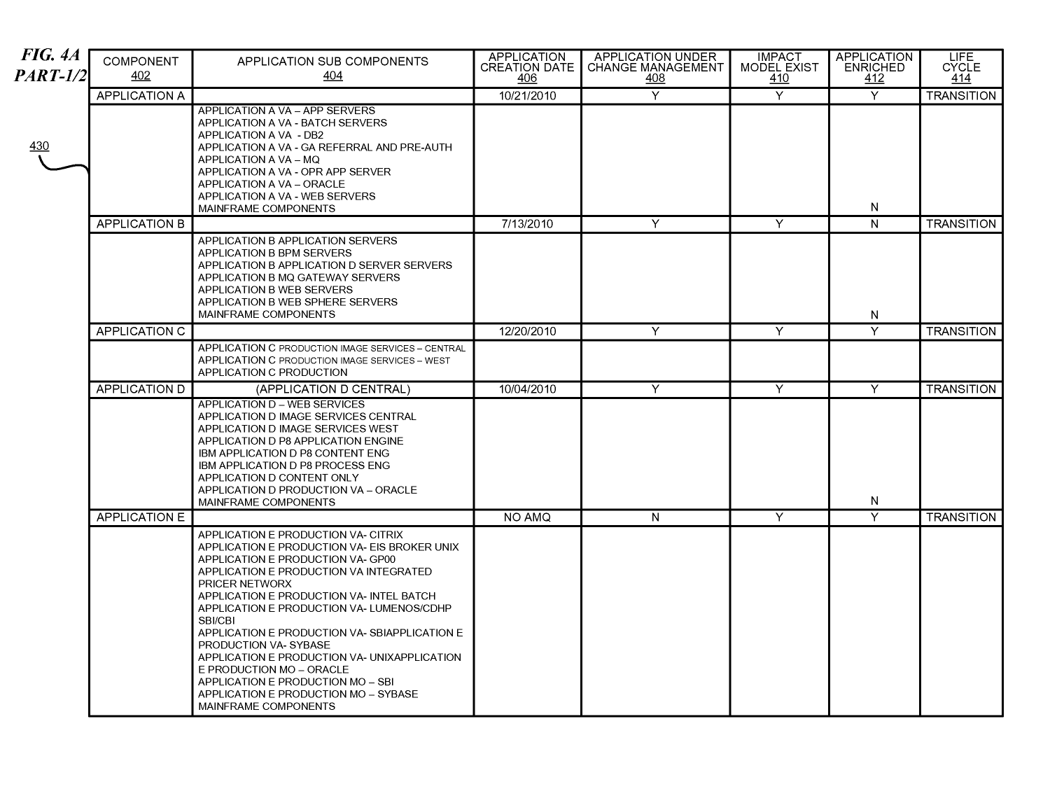

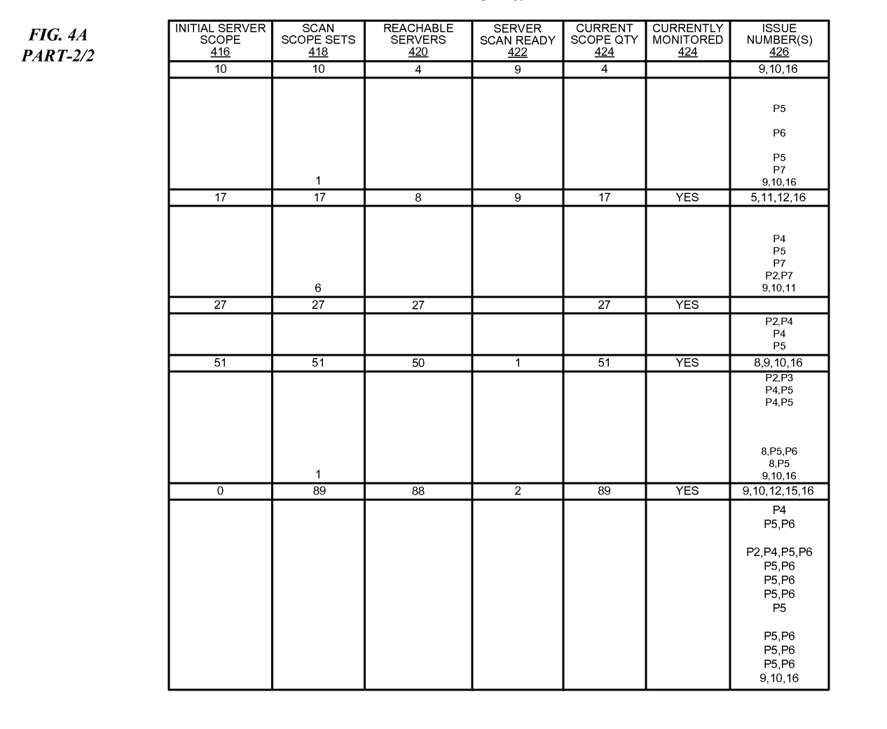

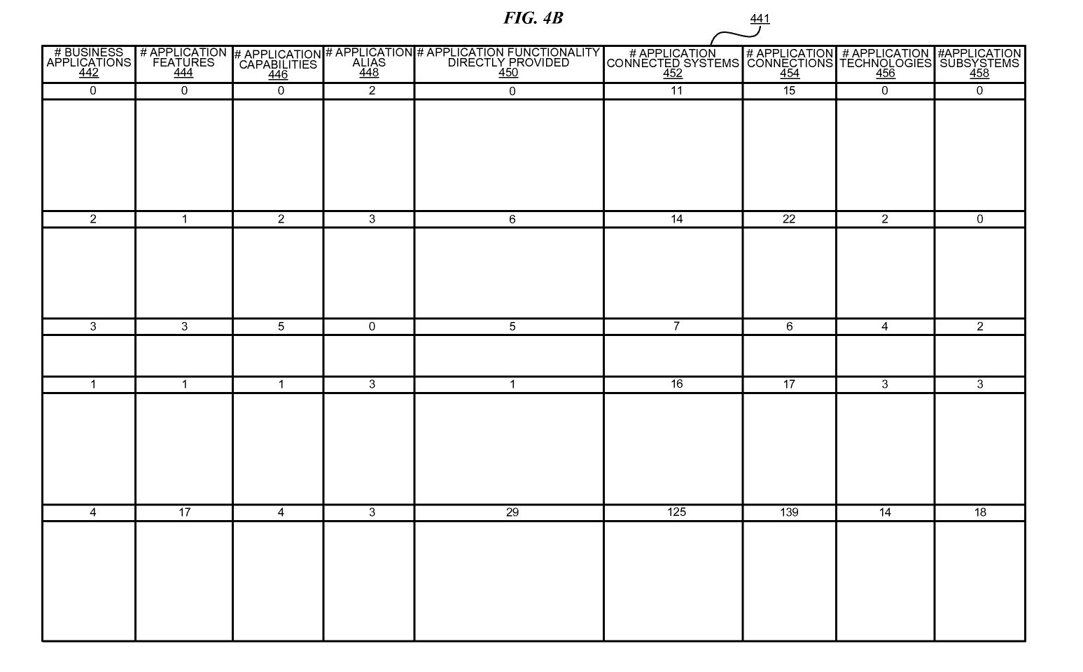

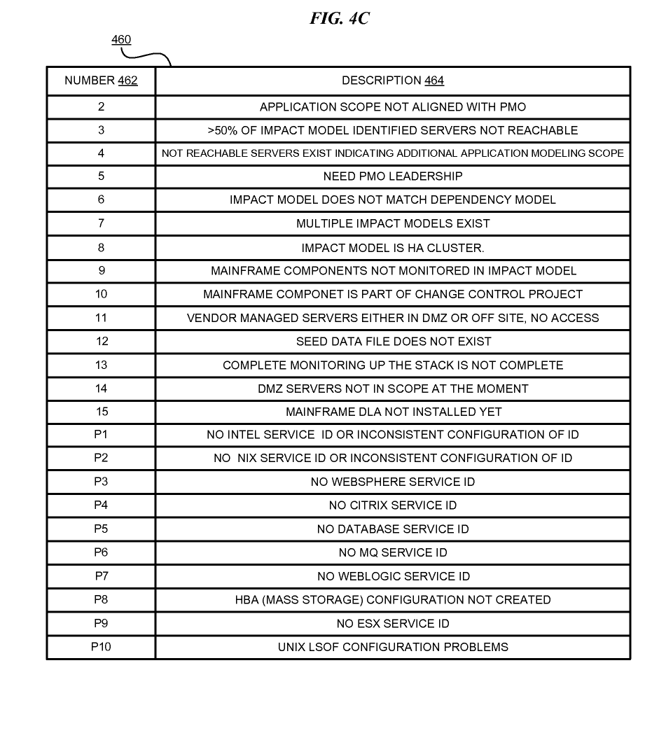

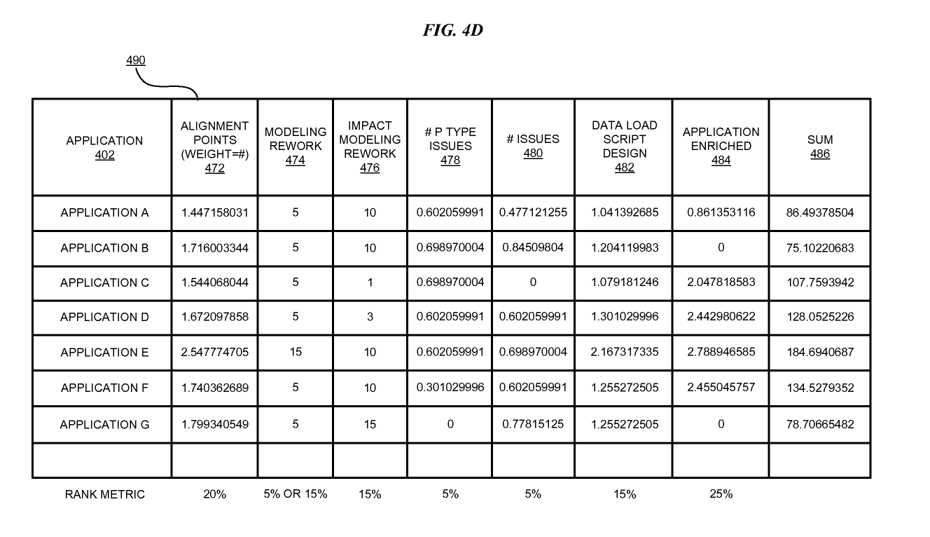

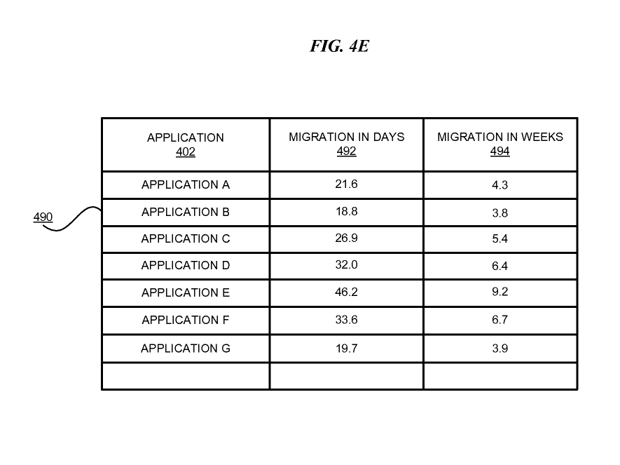

With reference to FIG. 4A, this figure depicts an example compilation of several example sets of contributing factors that can be used for weight factor determination in accordance with an illustrative embodiment. The weight factor can be used in weights 310 in FIG. 3.

Table 400 is an example manner of depicting the several sets of the contributing factors, and is depicted in two parts—part 1-of-2 and part 2-of-2—that should be considered together. Column 402 lists the components whose contributing factors are compiled in table 400. Column 404, 406, 408, 410, 412, 414, 416, 418, 420, 422, 424, 426, and 428 each lists an example contributing factor in a set of contributing factors for a corresponding component listed in column 402.

Consider row 430 as an example for the purposes of the following description. Row 430 can include a value for the component of column 402 as a whole, a value for some or all sub-components listed in column 404 for the component listed in column 402, or a combination thereof.

Column 404 shows the sub-components of component “Application A” listed in column 402 in row 430. Continuing in row 430, column 406 lists the date application A was created, and column 408 informs whether application A is a part of a change management program. Column 410 informs whether an impact model for application A exists, and column 412 informs whether application A has been “enriched” or modified.

Column 414 provides the information about a lifecycle phase, such as a phase in Information Technology Infrastructure Library (ITIL), in which application A exists at the time of capturing the contributing factors. Column 416 provides an initial number of servers within the scope of application A. Column 418 provides a number of those servers in the scope that are part of a discovery, such as according to an application dependency discovery application. Column 420 provides a number of those servers that are actually reachable. Column 422 provides a number of servers in the scope that are ready for discovery. Column 424 provides a number of servers that are within the current scope, such as by being reachable at the time of collecting the contributing factors. Column 426 provides a number of those servers that are monitored at such current time. Column 428 provides a set of issues, troubles, problems, action-items associated with application A or a sub-component thereof.

As described elsewhere in this disclosure, an embodiment uses one or more of the contributing factors for a given component for determining a weight or weight factor value to serve as input 310 to estimation application 306 in FIG. 3. These contributing factors are depicted and described only as examples and not as limitations on the illustrative embodiments. Those of ordinary skill in the art will be able to conceive from this disclosure many other contributing factors to determining weights or weight factors in a similar manner, and the same are contemplated within the scope of the illustrative embodiments.

With reference to FIG. 4B, this figure depicts an example compilation of several example sets of analysis parameters that can be used for estimating the time needed to model a data processing environment in accordance with an illustrative embodiment. Table 440 is an example manner of depicting the several sets of the analysis parameters, and is depicted relative to column 402 of table 400 in FIG. 4A. Values in a row of table 440 should be considered together with the component and sub-components depicted in a corresponding row of table 400 in columns 402 and 404. The analysis parameters can be used as analysis parameters 308 in FIG. 3.

Column 442, 444, 446, 448, 450, 452, 454, 456, and 458 each lists an example analysis parameter in a set of analysis parameters for a corresponding component listed in column 402 in table 400 in FIG. 4A.

Consider row 441, which corresponds to row 430 in table 400 in FIG. 4A, as an example for the purposes of the following description. Column 442 in row 441 shows a number of applications within component application A of row 430. Column 444 shows a number of features offered by application A, and column 446 shows number of capabilities supported in application A. Column 448 shows a number of aliases used for referencing application A, such as from other hardware, software, or firmware components. Column 450 identifies a number of the functionalities directly provided by application A. Column 452 shows a number of systems connected with application A. Column 454 shows a number of connections established with application A. Column 456 shows a number of application technologies used in or with application A, and column 458 shows a number of application subsystems within application A.

As described elsewhere in this disclosure, an embodiment uses one or more of the analysis parameters for a given component as input 308 to estimation application 306 in FIG. 3. These analysis parameters are depicted and described only as examples and not as limitations on the illustrative embodiments. Those of ordinary skill in the art will be able to conceive from this disclosure many other analysis parameters for a similar purpose, and the same are contemplated within the scope of the illustrative embodiments.

With reference to FIG. 4C, this figure depicts an example compilation of several example issues, troubles, problems, action-items associated with a component that can be used for estimating the time needed to model a data processing environment in accordance with an illustrative embodiment. Table 460 is an example manner of depicting the set of issues, troubles, problems, action-items (collectively, issues). An issue identified in table 460 can be used in column 428 in FIG. 4A.

Column 462 lists an identifier associated with an issue. Column 464 lists a description of the corresponding issue. Issues in a given data processing environment can be classified into different groups. For example, as depicted, one group of issues can be represented with only numeric identifiers. Another group can be represented using alphanumeric identifiers. Any suitable manner of grouping issues can similarly be used within the scope of the illustrative embodiments.

With reference to FIG. 4D, this figure depicts example computations, and an example manner of compiling the computed or derived values resulting from those computations, for estimating the time needed to model a data processing environment in accordance with an illustrative embodiment. Table 470 is depicted relative to column 402 of table 400 in FIG. 4A. Values in a row of table 470 should be considered together with the component and sub-components depicted in a corresponding row of table 400 in columns 402 and 404.

Table 470 includes computations according to certain formulae in columns 472, 478, 480, 482, 484, and 486. Estimation application 306 of FIG. 3 performs the computations using data from one or more columns in tables 400 and 440 in FIGS. 4A-4C.

As an example, a weight value in column 472 of row 471 corresponds to a cumulative weight factor computed for the component “Application A” in column 402 of table 400 in FIG. 4A. In one embodiment, the formula for computing the weight in column 472 adds the values in row 441, and computes a logarithmic value of the sum in Base 10. In other words, the weight in column 472 of row 471, as depicted according to an embodiment, is—

LOG₁₀(sum of values in column 442, 444, 446, 448 450, 452, 454, 456, and 458, in row 441)

Columns 474 and 476 include values provided by a user or computed based on statistical or historical data about the data processing environment in question. When computed, estimation application 306 of FIG. 3 performs those computations for the values in columns 474 and 476.

For example, the weight value in column 474 is indicative of the accuracy and rework effort required in the modeling based on the accuracy of an existing application model. Example value of 5 indicates five percent of rework, and is assigned where less than a threshold amount of rework is needed. Similarly, a value of 15 indicated fifteen percent of rework, and is assigned where more than another threshold amount of rework is needed.

Note that the values 5 and 15 have been chosen only as example values, and other values in other suitable ranges may be more appropriate in a different data processing environment. In the depicted example, values corresponding to five and fifteen percent are derived based on previous modeling efforts and time spent in capturing a desired amount and type of data to enable the previous modeling effort.

As another example, the value in column 476 is indicative of the modeling effort that has been previously needed to model application A based on an analysis of the impact models that have been previously developed for application A, and the amount of stale or reusable data found representing the previous model. Example values of 1, 3, 10, and 15 indicate corresponding percentages of rework expected to be needed.

Note that the values 1, 3, 10, and 15 have been chosen only as example values. Other values in other suitable ranges may be more appropriate in a different data processing environment.

As an example, a weight value in column 478 of row 471 corresponds to one type of issues-related weight factor computed for the component “Application A” in column 402 of table 400 in FIG. 4A. In one embodiment, the formula for computing the weight in column 478 computes a logarithmic value of the number of “P” type issues in Base 10. As shown in row 430 under column 428, four “P” issues belonging to the alphanumerically identified issues of table 460 are associated with sub-components of application A. In other words, the weight in column 478 of row 471, as depicted according to an embodiment, is—

LOG₁₀(4)

As an example, a weight value in column 480 of row 471 corresponds to another type of issues-related weight factor computed for the component “Application A” in column 402 of table 400 in FIG. 4A. In one embodiment, the formula for computing the weight in column 480 computes a logarithmic value of the number of numerically identified issues in Base 10. As shown in row 430 under column 428, three issues belonging to the numerically identified issues of table 460 are associated with sub-components of application A. In other words, the weight in column 480 of row 471, as depicted according to an embodiment, is—

LOG₁₀(3)

As an example, a weight value in column 482 of row 471 corresponds to another weight factor computed for the component “Application A” in column 402 of table 400 in FIG. 4A. This weight factor accounts for the level of scripting design that is required to model application A. In one embodiment, the formula for computing the weight in column 482 adds the values under columns 442, 452, and 458 in row 441, and computes a logarithmic value of the sum in Base 10. In other words, the weight in column 482 of row 471, as depicted according to an embodiment, is—

LOG₁₅(sum of values in column 442, 452, and 458, in row 441)

As an example, a weight value in column 484 of row 471 corresponds to another weight factor computed for the component “Application A” in column 402 of table 400 in FIG. 4A. This weight factor accounts for the level of enrichment involved in each service model for application A. In one embodiment, the formula for computing the weight in column 484 adds the values under columns 442, 452, and 458 in row 441, and computes a logarithmic value of the sum in Base 5. In other words, the weight in column 484 of row 471, as depicted according to an embodiment, is—

LOG₅(value in column 424)

As an example, a weight value in column 486 of row 471 corresponds to a cumulative weight factor computed for the component “Application A” in column 402 of table 400 in FIG. 4A. This weight factor accounts for the various weights in columns 472, 474, 476, 478, 480, 482, and 484 according to the percentages allocated to each column in the sum according to a ranking metric in row 488. In one embodiment, as shown, the formula for computing the weight in column 486 adds twenty percent of the value under columns 472 (i.e., ranked value of column 472), the value under column 474 (which is depicted as percentage in the example and is a ranked value in itself), the value shown under 476 (which is depicted as percentage in the example and is a ranked value in itself), five percent of the value under columns 478 (i.e., ranked value of column 478), five percent of the value under columns 480 (i.e., ranked value of column 480), fifteen percent of the value under columns 482 (i.e., ranked value of column 482), and twenty five percent of the value under columns 484 (i.e., ranked value of column 484), and computes a logarithmic value of the sum in Base 10. In other words, the weight in column 486 of row 471, as depicted according to an embodiment, is—

LOG₁₀(sum of ranked values in column 472, 474, 476, 478, 480, 482, and 484, in row 441)

The sum computed in column 486 is a measure of the estimate of time expected to be consumed in modeling the data processing environment where application A operates with other components, such as application B-G as shown.

With reference to FIG. 4E, this figure depicts example computations of time estimates for modeling a data processing environment in accordance with an illustrative embodiment. Table 490 is depicted relative to column 402 of table 400 in FIG. 4A. Values in a row of table 490 should be considered together with the component and sub-components depicted in a corresponding row of table 400 in columns 402 and 404.

Table 490 includes computations according to certain formulae in columns 492, and 494. Estimation application 306 of FIG. 3 performs these computations using the sum values in column 486 in table 470 in FIG. 4D.

As an example, assume that a model is to be prepared of a data processing environment where applications A-G operate. The model is to be used for migrating application A-G within the data processing environment. An embodiment computes time estimate for modeling application A for migration using the formula value in column 486 in row 441 divided by 4, to account for an average of four weeks per month, to yield the time estimate in number of days in column 492. The embodiment computes the time estimate in number of weeks by dividing the corresponding value in column 492 by the number of working days in a week, e.g., 5.

The example numbers, percentages, weight values, rank metrics, combinations of contributing factors, and combinations of analysis parameters used and described in the description of FIGS. 4A-E are not intended to be limiting on the illustrative embodiments. Furthermore, the example manner of representing those numbers, values, and percentages is also not intended to be limiting on the illustrative embodiments. Different numbers, percentages, weight values, rank metrics, combinations of contributing factors, combinations of analysis parameters, and manners of using the same will be suitable for different data processing environment implementations, and the same are contemplated within the scope of the illustrative embodiments.

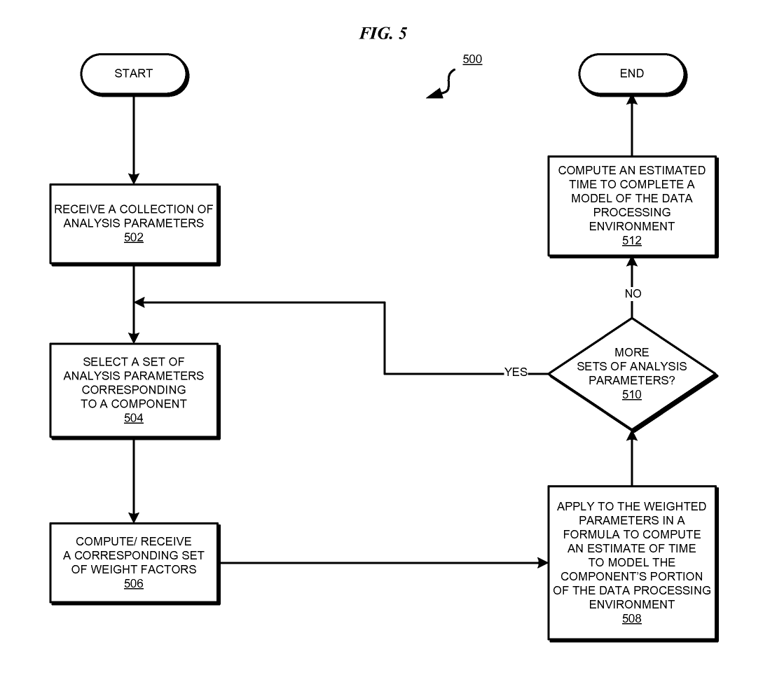

With reference to FIG. 5, this figure depicts a flowchart of an example process for estimating the time needed to model a data processing environment in accordance with an illustrative embodiment. Process 500 can be implemented in estimation application 306 in FIG. 3.

Estimation application 306 receives a collection of analysis parameters, such as analysis parameters from several rows of table 440 in FIG. 4B (step 502). Estimation application 306 selects a set of analysis parameters corresponding to a component from the collection, such the set of analysis parameters from row 441 in table 440 in FIG. 4B (step 504).

Estimation application 306 computes or receives a corresponding set of weight factors to apply to the analysis parameters, such as in the example manner described with respect to FIGS. 4A-E (step 506). Estimation application 306 applies rank metrics from a set of rank metrics to one or more weighted parameters computed in step 506 (step 508). The computing and the applying operations of steps 506 and 508, respectively, use one or more formulae similar to those described with respect to FIGS. 4A-E. The applying operation of step 508 produces an estimate of time needed to model the component's portion of the data processing environment.

Estimation application 306 determines whether more sets of analysis parameters remain in the collection received in step 502 (step 510). If more sets remain (“Yes” path of step 510), estimation application 306 returns to step 504 and selects another set corresponding to another component. If no more sets remain (“No” path of step 510), estimation application 306 computes an estimated time to model the data processing environment (step 512). Estimation application 306 ends process 500 thereafter.

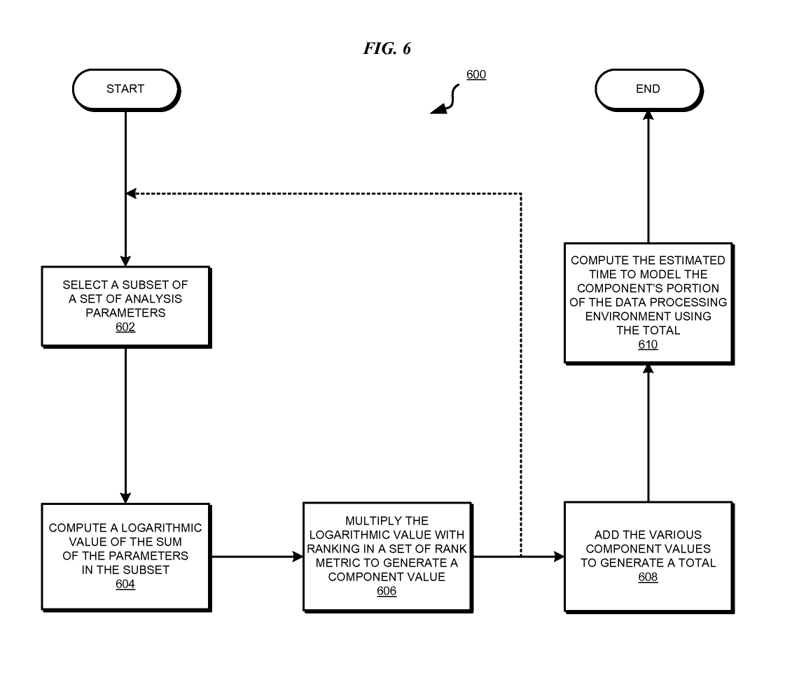

With reference to FIG. 6, this figure depicts a flowchart of an example process for computing a component's portion of the estimated modeling time in accordance with an illustrative embodiment. Process 600 can be implemented in steps 506 and 508 in process 500 in FIG. 5, using estimation application 306 in FIG. 3.

Estimation application 306 begins by selecting a subset of a set of analysis parameters, such as from the set selected in step 504 in FIG. 5 (step 602). Estimation application 306 computes a logarithmic value in a specific Base, such as Base 10 or 5, of the sum of the parameters in the subset (step 604).

Estimation application 306 multiplies the Base 10 logarithmic value with a ranking value from a set of rank metrics to generate a component value (step 606). Estimation application 306 repeats steps 602, 604, and 606 for various subsets of analysis parameters, as described in an example manner with respect to FIGS. 4A-E, to generate several component values.

Estimation application 306 adds the various component values to generate a total (step 608). Estimation application 306 computes an estimated time to model the component's portion of the data processing environment using the total from step 608 (step 610). Estimation application 306 ends process 600 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for estimating the time needed to model a data processing environment. Using an embodiment, an estimation application can estimate an amount of time a modeling activity is likely to take to model a data processing environment of a given configuration. The estimation application can estimate the modeling time on a per component basis, and generate the total time for the data processing environment model as a whole. Furthermore, the estimation application can be configured to tailor the estimates to specific activities planned using the model, such as by altering the set of analysis parameters, weight factors, percentages and values, rank metrics, logarithmic base values or a combination thereof used in the computations.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for estimating an amount of time to model a data processing environment, the method comprising:
selecting, using one or more processors, a set of analysis parameters;
computing, using the one or more processors, a sum of a subset of the set of analysis parameters;
computing, using the one or more processors, a logarithmic value of the sum;
weighting, using the one or more processors, the logarithmic value; and
estimating, using the one or more processors, the amount of time to model the data processing environment using the logarithmic value.

2. The method of claim 1, further comprising:
computing, using the one or more processors, a second sum of a second subset of the set of analysis parameters; and
computing, using the one or more processors, a second logarithmic value of the second sum, and
combining, using the one or more processors, the logarithmic value with the second logarithmic value.

3. The method of claim 2, wherein the logarithmic value and the second logarithmic value are each computed using different bases.

4. The method of claim 3, wherein the logarithmic value is in Base 10 and the second logarithmic value is in Base 5.

5. The method of claim 1, further comprising:
computing, using the one or more processors, a set of weight factors, wherein the computing the set of weight factors uses historical information of the data processing environment to determine the weight factors in the set of weight factors, and wherein the weighting uses a weight factor from the set of weight factors.

6. The method of claim 1, further comprising:
receiving, using the one or more processors, a set of weight factors, wherein the set of weight factors is received from a user.

7. The method of claim 1, further comprising:
receiving, using the one or more processors, a collection of analysis parameters, the collection including the set of analysis parameters.

8. The method of claim 1, wherein the set of analysis parameters is received from an analysis application executing in the data processing environment.

9. A computer program product comprising one or more computer-readable tangible storage devices and computer-readable program instructions which are stored on the one or more storage devices and when executed by the one or more processors, perform the method of claim 1.

10. A computer system comprising the one or more processors, one or more computer-readable memories, one or more computer-readable tangible storage devices and program instructions which are stored on the one or more storage devices for execution by the one or more processors via the one or more memories and when executed by the one or more processors perform the method of claim 1.

11. A computer program product for estimating an amount of time to model a data processing environment, the computer program product comprising:
one or more computer-readable storage devices and program instructions stored on at least one of the one or more storage devices, the program instructions comprising:
program instructions to select, using one or more processors, a set of analysis parameters;
program instructions to compute, using the one or more processors, a sum of a subset of the set of analysis parameters;
program instructions to compute, using the one or more processors, a logarithmic value of the sum;
program instructions to weight, using the one or more processors, the logarithmic value; and
program instructions to estimate, using the one or more processors, the amount of time to model the data processing environment using the logarithmic value.

12. The computer program product of claim 11, further comprising:
program instructions stored on at least one of the one or more storage devices to compute, using the one or more processors, a second sum of a second subset of the set of analysis parameters; and
program instructions stored on at least one of the one or more storage devices to compute, using the one or more processors, a second logarithmic value of the second sum, and
program instructions stored on at least one of the one or more storage devices to combine, using the one or more processors, the logarithmic value with the second logarithmic value.

13. The computer program product of claim 12, wherein the logarithmic value and the second logarithmic value are each computed using different bases.

14. The computer program product of claim 13, wherein the logarithmic value is in Base 10 and the second logarithmic value is in Base 5.

15. The computer program product of claim 11, further comprising:
program instructions stored on at least one of the one or more storage devices to compute, using the one or more processors, a set of weight factors, wherein the computing the set of weight factors uses historical information of the data processing environment to determine the weight factors in the set of weight factors, and wherein the weighting uses a weight factor from the set of weight factors.

16. The computer program product of claim 11, further comprising:
program instructions stored on at least one of the one or more storage devices to receive, using the one or more processors, a set of weight factors, wherein the set of weight factors is received from a user.

17. The computer program product of claim 11, further comprising:
program instructions stored on at least one of the one or more storage devices to receive, using the one or more processors, a collection of analysis parameters, the collection including the set of analysis parameters.

18. The computer program product of claim 11, wherein the set of analysis parameters is received from an analysis application executing in the data processing environment.

19. A computer system for estimating an amount of time to model a data processing environment, the computer system comprising:
one or more processors, one or more computer-readable memories, one or more computer-readable storage devices, and program instructions stored on at least one of the one or more storage devices for execution by at least one of the one or more processors via at least one of the one or more memories, the program instructions comprising:
program instructions to select, using one or more processors, a set of analysis parameters;
program instructions to compute, using the one or more processors, a sum of a subset of the set of analysis parameters;
program instructions to compute, using the one or more processors, a logarithmic value of the sum;
program instructions to weight, using the one or more processors, the logarithmic value; and
program instructions to estimate, using the one or more processors, the amount of time to model the data processing environment using the logarithmic value.

20. The computer system of claim 19, further comprising:
program instructions, stored on at least one of the one or more storage devices for execution by at least one of the one or more processors via at least one of the one or more memories, to compute, using the one or more processors, a second sum of a second subset of the set of analysis parameters; and
program instructions, stored on at least one of the one or more storage devices for execution by at least one of the one or more processors via at least one of the one or more memories, to compute, using the one or more processors, a second logarithmic value of the second sum, and
program instructions, stored on at least one of the one or more storage devices for execution by at least one of the one or more processors via at least one of the one or more memories, to combine, using the one or more processors, the logarithmic value with the second logarithmic value.
